(19) United States
(12) Patent Application Publication
(10) Pub. No.: US 2024/0225050 A1
(43) Pub. Date: Jul. 11, 2024

(54) A METHOD FOR REFINING MACROALGAE

(71) Applicant: Origin by Ocean, Espoo (FI)

(72) Inventors: Mari GRANSTRÖM, Espoo (FI); Mikael WESTERLUND, Espoo (FI)

(73) Assignee: Origin by Ocean, Espoo (FI)

(21) Appl. No.: 18/558,834

(22) PCT Filed: May 5, 2022
(86) PCT No.: PCT/FI2022/050300

§ 371 Date: Nov. 3, 2023

(30) Foreign Application Priority Data
May 6, 2021 (FI) 20215533

(51) Int. Cl. A23K 10/30; A23K 40/00

(52) U.S. Cl. CPC A23K 10/30; A23K 40/00

(57) ABSTRACT

The present disclosure relates to the method for refining macroalgae, which method is used for obtaining animal feed derived from macroalgae. The method of the present disclosure enables producing low cost animal feed due to the upgrading methodology of valuable side stream products. Valuable components are recovered from the macroalgae separately and a lower cost biomass product is obtained which is suitable to be used as animal feed.

### FIELD OF THE DISCLOSURE

The present disclosure relates to the method for refining macroalgae, which method is used for obtaining animal feed derived from macroalgae.

### BACKGROUND OF THE DISCLOSURE

Macroalgae has been used as a supplement feed resource in animal feeds. However, it has not been suitable as animal feed as such or as the main component because of the poor nutritional intake.

Macroalgae contain varying levels of nutrients depending on species, season of harvest, geographic origin, and environmental conditions. The protein and nutritionally essential amino acids content can be rather low and variable, especially in brown macroalgae, when considered against the amino acid requirement of most aquacultural and terrestrial animal species. Macroalgae have high content of recalcitrant polysaccharide components such as alginates and carrageenans, which are not digested to any extent by monogastric animal species, causing challenges in using macroalgae in animal feed. This reduces the nutritionally available energy content of macroalgae and most algae-derived products.

The application of the entire biomass in a dry meal means that the nutritional value of the final product is greatly dependent on the macroalgal species, season, and other factors influencing chemical composition. In addition, the nutritional properties may depend on the drying methods employed. Oven drying by fossil energy is on the other hand energy intensive and costly.

Marine macroalgae are known for their high mineral content and have traditionally been used as a mineral supplement for farm animals. Although macroalgae are rich in nutritionally important minerals such as iodine, potassium, calcium, magnesium, phosphorus, iron, and zinc, macroalgae can also accumulate large amounts of heavy metals, and the high levels of arsenic, lead, cadmium, and other heavy metals in some species can limit their use in animal feeds. Low bioavailability of an undesirable component means high levels will be excreted in manure, which in turn will be applied to field crops. Also, the level of iodine in some macroalgal species, especially the brown species within Laminaria and Saccharina that can contain up to 12 000 mg/kg dry weight, can limit their use in animal feed.

Seaweed, or macroalgae, refers to thousands of species of macroscopic, multicellular, marine algae. The term includes some types of Rhodophyta (red), Phaeophyta (brown) and Chlorophyta (green) macroalgae. Macroalgae are typically characterized by their large size and high productivity, and they are easily accessible in many locations, but the chemical composition of the whole biomass is not suitable for high inclusion rates in animal diets. The low levels of protein and metabolizable energy, and the high mineral content of intact seaweeds like brown seaweeds Laminaria spp. and A. nodosum, prohibit their use as replacements for major protein sources such as fishmeal and soybean meal in formulated feed for monogastric animals

Thus, there is a need for a method which overcomes the above mentioned problems and provides animal feed which can be easily administered to the animals.

### BRIEF DESCRIPTION OF THE DISCLOSURE

An object of the present disclosure is to provide a method which enables production of animal feed derived from macroalgae.

The object of the disclosure is achieved by a method which is characterized by what is stated in the independent claim. The preferred embodiments of the disclosure are disclosed in the dependent claims.

The disclosure is based on developing a single process wherein macroalgae is refined in such a way that nutritional animal feed is obtained. The method also enables the recovery of side streams which may be further processed to valuable end products. The method of the disclosure enables that a large amount of macroalgae is collected from ocean and then processed using the method of the present invention.

### BRIEF DESCRIPTION OF THE DRAWINGS

In the following the invention will be described in greater detail by means of preferred embodiments with reference to the accompanying drawings, in which

FIG. 1 illustrates steps a) to e) and step o) of the method for refining macroalgae in a simple flow chart.

### DETAILED DESCRIPTION OF THE DISCLOSURE

The disclosure relates to a method for preparing animal feed comprising at least the following steps:
a) providing a mixture comprising macroalgae and water and performing at least one pretreatment of said mixture to break cell structure of the macroalgae
b) separation of pretreated mixture obtained in step a) to obtain liquid phase and solid phase and recovering the obtained phases separately
c) purification of the solid phase obtained in step b) by addition of aqueous acidic solution into the solid phase to lower mineral content of the solid phase and recovering purified solid phase and aqueous phase separately
d) extraction of the purified solid phase obtained in step c) in alkaline conditions by addition of basic solution to provide solid macroalgae biomass product animal feed and liquid product B comprising polysaccharides and sugars and recovering the macroalgae biomass product animal feed and product B separately.

The method of the present disclosure enables producing low cost animal feed due to the upgrading methodology of valuable side stream products. Valuable components are recovered from the macroalgae separately and a lower cost biomass product is obtained which is suitable to be used as animal feed as such. There are masses of macroalgae in the seas and this method enables processing large masses of macroalgae providing animal feed with a suitable nutritional composition for animals as well as recovery of higher price side streams products, such as pigments, polysaccharides, sugars and phytosterols. The method also enables the recycling of nutrients from the sea to the land. Nutrients such as phosphorous and nitrogen contained in macroalgae are consumed by the animals, such as cattle, and the nutrients are returned to the land in the manure of the animals. Phosphorous and nitrogen exist in the feed in their natural form and hence the concentration of synthetic nutrient load to the environments, especially the waterways, is decreased. Nutrients used by the cattle are recycled from the sea to the land via macroalgae.

The term macroalgae, also called seaweed, refers to any species of macroscopic, multicellular, marine algae. Marine macroalgae are a diverse group of multicellular, plant-like protists that can be classified into brown (Phaeophyta), green (Chlorophyta) and red (Rhodophyta) algae. Macroalgae, such as Fucus Vesiculosus, or Sargassum, is treated in the biorefinery process by the method of the present disclosure to afford biomass product targeted for animal feed owning a certain composition originating from the method used.

The pretreatment step comprises at least a step where a mixture comprising macroalgae and water is pretreated to break cell structure of the macroalgae. Breaking the cell structure of the macroalgae releases intra- and intercellular components into an aqueous layer. This pretreatment facilitates efficient recovery of different products in the refining process. Macroalgae having its natural moisture can also be pretreated to reduce the size of macroalgae if necessary. There is no need to dry the macroalgae before the pretreatment, but it is possible to use wet macroalgae which minimizes the need for additional water in the process. Cell structure of the macroalgae can be broken using e.g. mechanical, chemical or enzymatic pretreatment. Different pretreatments may be performed either one at a time or they may be combined in any order in step a) of the method.

In an embodiment of the disclosure pretreatment used comprises mechanical pretreatment. A mixture comprising macroalgae and water is pretreated by a mechanical pretreatment to break cell structure of the macroalgae. The moisture content of the macroalgae to be pretreated is preferably between 40-70 wt %. Mechanical pretreatment can reduce the size of macroalgae in order to facilitate the separation following the pretreatment step. The desired size of macroalgae depends on the mechanical pretreatment parameters used and it may be for example very fine, 1 mm or 2 mm.

Mechanical pretreatment can be performed using e.g. a knife mill, a refiner, a disc refiner, a conical refiner, a pelletizer, a rotating rotor, a rotor-stator mechanism, a shredder, a meat-bone separator, deboner, extruder, homogenizer and/or fluidizator. According to an embodiment of the disclosure mechanical pretreatment is performed using a rotor-stator mechanism.

Mechanical pretreatment can be combined with chemical and/or enzymatic pretreatments. Chemical and/or enzymatic pretreatments can be carried out during the storage phase before the step a) of the method of the invention and/or they can be carried out in combination with mechanical pretreatment during step a) of the method. Combination of several pretreatments may be chosen based on the need to provide better storage life for the macroalgae and/or to further facilitate the processing of macroalgae and recovery of different products and compounds from the process.

According to an embodiment of the disclosure chemical pretreatment is performed by degradation of plant cell walls with formic acid blends containing different concentrations of formic acid or sodium formate. In other words, formic acid blends may comprise one or more component(s) selected from formic acid and sodium formate. In addition, formic acid blends may comprise one or more component(s) selected from propionic acid, sodium benzoate, potassium sorbate, glycerol, propylene glycol, ammonium propionate, or any mixtures thereof. Plant cell walls mean the cell walls of the macroalgae. Thus, this pretreatment also breaks the cell structure of the macroalgae. Chemical pretreatment using formic acid blends also facilitates the storage of macroalgae. This pretreatment can also be performed in combination with the mechanical pretreatment.

Enzymatic pretreatment can also be used to facilitate the breaking of plant cell walls and releasing of polysaccharides from the cellular structure. Thus, used in step a) to break the cell structure of the macroalgae. Enzymatic pretreatment can be performed using an enzyme or different blends of enzymes during storage of macroalgae or in combination with other pretreatments used in the method. The enzyme used can be e.g. cellulase, glucohydrolase, xylanase, β-glucosidase16 and/or alginate lyase or an enzyme mix comprising them.

Pretreatment in step a) is typically carried out at a temperature in the range of 0° C. to 80° C. or 10° C. to 80° C., or 15° C. to 80° C. Preferably, the temperature is maintained in the range of 0° ° C. to 40° C., or at a temperature in the range of at least 0° C. to less than 40° C. More preferably, the temperature is maintained in the range of 10° C. to 40° C., or at a temperature in the range of at least 10° C. to less than 40ºC.

In step b) of the method separation is performed to obtain solid phase and liquid phase, and then the obtained phases are recovered separately. Separation and recovery of the phases can be performed in any method known in the art. In an embodiment the separation is pre-extraction performed by addition of alcohol(s) into the process to separate solid phase and liquid phase. Pre-extraction can be carried out using aqueous solution containing alcohol or mixture of alcohol(s) and organic solvents. Suitable alcohols and solvents are for example methanol, ethanol, acetone and/or methanol/acetone mixture which provide good separation of liquid phase and solid phase. Methanol and acetone may be mixed in a range of 9:1-1:9, preferably in a range 8:2-3:7.

Step b) is typically carried out at a temperature in the range of 0° C. to 80° C., or 10° C. to 80° C., or 15° ° C. to 80° C. Preferably, the temperature is maintained in the range of 0° C. to 40° C., or at a temperature in the range of at least 0° C. to less than 40° C. More preferably, the temperature is maintained in the range of 10° C. to 40° C., or at a temperature in the range of at least 10° C. to less than 40ºC.

In step c) the solid phase obtained in step b) is purified by addition of aqueous acidic solution into the solid phase to lower mineral content of the solid phase and then purified solid phase and liquid aqueous phase are recovered separately. The solid phase obtained in step b) is first purified by lowering pH by adding aqueous acidic solution to lower mineral content of the solid phase. According to an embodiment in step c) purification is acid wash, which is performed for lowering the mineral concentration of the macroalgae preparing it for the following steps. Acid wash may be performed using an effective amount of any mineral acid, e.g. HCl, which is contacted with the solid phase obtained in step b). The acid reacts with and solubilize the minerals lowering the mineral content of the solid phase. A suitable pH range for acid wash is 2-4. Alternatively, a pH range of 1-5 or pH<5 may be used.

Acid wash in step c) is typically carried out at a temperature in the range of 0° ° C. to 80° C. or 10° C. to 80° C., or 15° C. to 80° C. Preferably, the temperature is maintained in the range of 0° ° C. to 40° C., or at a temperature in the range of at least 0° C. to less than 40° C. More preferably, the temperature is maintained in the range of 10° C. to 40° C., or at a temperature in the range of at least 10° C. to less than 40ºC.

After the purification in step c), purified solid phase and aqueous phase are recovered separately e.g. by using filtration. Aqueous phase obtained can be circulated back to the process e.g. in step a). Thus, the aqueous phase from the process after the purification in step c) can be circulated into the mixture of water and macroalgae to be pretreated in step a). Thus, less water needs to be introduced into the process from outside of the process if there is need to add water to the mixture of water and macroalgae.

The purified solid phase obtained in step c) is then further processed by extraction in step d) in alkaline conditions, which is achieved by addition of basic solution. This extraction separates a liquid phase (Product B), which can also be called as an extract, containing water-soluble materials (polysaccharides, sugars, etc.) from the purified solid phase obtained in step c). Extraction, such as reactive extraction, is carried out under alkaline conditions to remove the polysaccharides and sugars from the purified solid phase obtained in step c). Alkaline conditions are provided in the method by adding basic solution, which is an aqueous solution of a base, to the process stream. After the extraction, the further purified solid phase (raffinate) is then recovered as solid macroalgae biomass product and the extract is recovered as liquid product B. A suitable pH for the extraction in alkaline conditions is 8-10.5. Alternatively, a pH of above 7 may be used. Suitable bases to be used are e.g. Na₂CO₃, NaOH or KOH.

Alkaline extraction in step d) is typically carried out at a temperature in the range of 0° C. to 80° C. or 10° C. to 80° C., or 15° C. to 80° C. Preferably, the temperature is maintained in the range of 0° C. to 40° C., or at a temperature in the range of at least 0° C. to less than 40° C. More preferably, the temperature is maintained in the range of 10° C. to 40° C., or at a temperature in the range of at least 10° C. to less than 40° C. Algal components including polysaccharides such as alginate, fucoidan and laminarin may start to degrade at temperatures above 40° C., so maintaining a lower temperature in step d) and throughout the process steps a) to d) helps maintain structural integrity of algal components.

In an embodiment extraction performed in step d) is reactive extraction performed using aqueous solution of Na₂CO₃, NaOH or KOH. Use of aqueous solution of Na₂CO₃, NaOH or KOH facilitates the separation of solid phase obtained in step c) into liquid phase containing water soluble materials and the solid phase, which is the macroalgae biomass product. The separated phases are then recovered separately and further processed.

Extraction in step d) may be carried out in an extruder, such as twin-screw press extruder, a rotor-stator mechanism, inline mixer, conveyor screw and/or reactor such as Lödige. According to an embodiment of the disclosure in step d) purified solid phase obtained in step c) is fed through an extruder (e.g. twin screw press extruder) where the reactive extraction is carried out with base (5-10% aqueous solution). In an embodiment, where the pre-treated material is very fine in size the extraction can be carried out using a regular reactor equipped with a stirrer.

After step d) Product B is recovered from the process as a side stream. Product B contains polysaccharides and sugars derived from macroalgae. The character of polysaccharides and sugars thus obtained depend on the macroalgae used.

In an embodiment, macroalgae used in the method is brown macroalgae. In such case polysaccharides such as alginate, fucoidan and laminarin as well as mixtures of sugars can be isolated from Product B and further purified using known methods to obtain further products.

Step d) produces macroalgae biomass product animal feed with a specific composition (Na, Ca, N, P, K, Fe) originating from the method. The biomass product thus has a favorable composition for use as an animal feed. Nutrients in the macroalgae are also present in the macroalgae biomass product animal feed which has nutrient value for the cattle. When the polysaccharides are removed from the macroalgae biomass product, it is more digestable for the cattle improving its nutrient intake while lowering methane and/or CO₂ emissions. Nutritional intake of the animals is improved as unwanted components, such as alginates, have been removed from the feed. Macroalgae biomass product contains components responsible for lowering cow's methane and/or carbon dioxide emissions.

It is possible to use the macroalgae biomass product obtained in step d) as such as animal feed. However, a further processing step e) can be used to extract phytosterols from macroalgae biomass product obtained in step d). Phytosterols provide another high value product that can be obtained from the method of the disclosure.

According to an embodiment of the disclosure the method for preparing animal feed further comprises a step e), wherein the macroalgae biomass product obtained in step d) is extracted to provide phytosterols (product F) and purified macroalgae biomass product animal feed, and the obtained products are recovered separately.

According to an embodiment this step e) is a refining step, wherein phytosterols are by extracted using aqueous solution containing alcohol to provide phytosterols and refined macroalgae biomass product. In this embodiment, macroalgae biomass product from step d) is fed into an extraction vessel where an aqueous solution containing alcohol is used for extraction of phytosterols, such as fucosterol. The phytosterols thus obtained depend on the type of macroalgae used in the method. Alcohol used may be for example ethanol, when the ethanol content used may be 50-90%. The remaining refined macroalgae biomass product which is obtained after the extraction of phytosterols can be used as animal feed in a same way as the macroalgae biomass product from step d).

Extraction in step e) is typically carried out at a temperature in the range of 0° C. to 80° C. or 10° ° C. to 80° C., or 60° ° C. to 80° C.

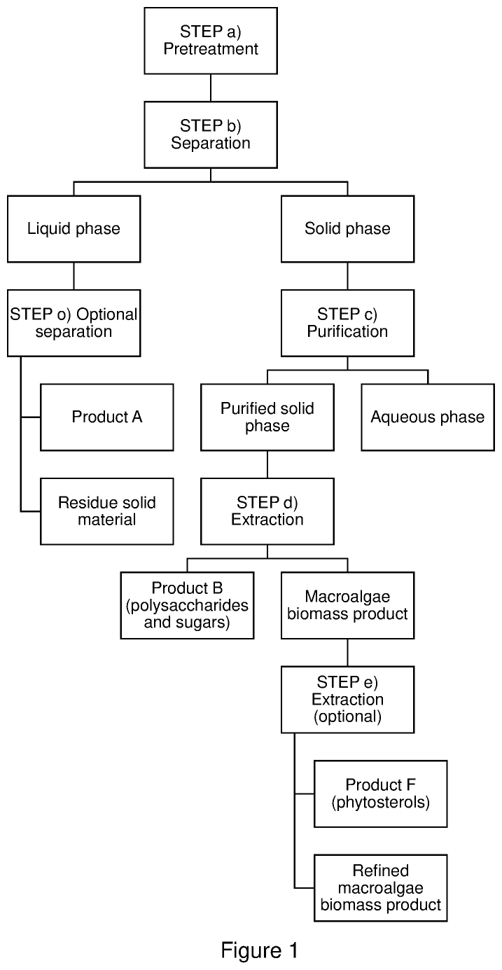

The present method provides also valuable products starting from the liquid phase obtained in step b). Liquid phase obtained in step b) containing several compounds, such as pigments, tannins, proteins, fatty acids and lipids, may be further separated in step o) to obtain further valuable products depending on the macroalgae used in the method. In FIG. 1 the product obtained by optional separation in step o) is called Product A. In an embodiment in step o) liquid phase obtained in step b) is separated to provide product A and residue solid material and the obtained product and material are recovered separately.

In an embodiment product A is pigments. Pigments may be collected as Product A from the separated liquid phase in step o) e.g. using column chromatography (normal or reversed phase). The remaining solid material obtained after the optional separation in step o) is called residue solid material containing the rest of the compounds such as polysaccharides, sugars, minerals and remaining tannins, proteins, fatty acids and lipids.

The present method has several advantages. New ecosystem of nutrient recycle is established where farmers can benefit from decreased nutrient and methane emissions when feeding the biomass product to the cattle. Due to the suitable level of nutrients such as sodium, calcium, potassium and iron in the obtained animal feed, there is no need to add or remove these nutrients into or from the animal feed. Thus, there is no such extra step involved when administering the feed to the animal. In an embodiment, the macroalgae biomass mass product obtained by a method according to any one of the embodiments is used as animal feed.

In an embodiment, the present invention provides animal feed product obtained by the method of the present invention, wherein the macroalgae biomass product used as animal feed contains 1-5 wt % Na and 4-12 wt % Ca.

In another embodiment, the present invention provides animal feed obtained by the method of the present invention, wherein the macroalgae biomass product animal feed contains 0.1-6 wt % Na and/or 1-12 wt % Ca in dry matter. Alternatively, the content of Na ranges from 0.5 to 6 wt %, or 0.5 to 5 wt %, or 1 to 5 wt % in dry matter. Alternatively, the content of Ca ranges from 4 to 12 wt %, or 1 to 10 wt %, or 2 to 10 wt % in dry matter.

In yet another embodiment, the present invention provides animal feed obtained by the method of the present invention, wherein the macroalgae biomass product animal feed contains up to 2.5 wt % K, or 0.01 to 2.5 wt % K, or 0.1 to 2 wt % K, or 0.1 to 1.5 wt % K in dry matter.

In a further embodiment, the present invention provides animal feed obtained by the method of the present invention, wherein the macroalgae biomass product animal feed contains at least 500 ppm Fe, or at least 800 ppm Fe, or at least 1000 ppm Fe in dry matter. Additionally or alternatively, the macroalgae biomass product animal feed contains up to 3000 ppm Fe, or up to 2500 ppm Fe, or up to 2000 ppm Fe in dry matter. Additionally or alternatively, the macroalgae biomass product animal feed contains Fe in the range of 500 to 3000 ppm, or 500 to 2500 ppm, or 800 to 2500 ppm in dry matter. As used herein, 1 ppm equals 1 mg/kg DM.

In a yet further embodiment, the present invention provides animal feed obtained by the method of the present invention, wherein the macroalgae biomass product animal feed contains 0.1-6 wt % Na, 1-12 wt % Ca, up to 2.5 wt % K and/or at least 500 ppm Fe in dry matter.

The present method unlocks known bottle necks for the processing parameters in terms of water economics since the raw material need not to be dried and hence, all the water from the macroalgae can be used in the method as a water source. Therefore, the total water intake and energy consumption is decreased. There is no need for separate drying steps within the method. In the present method the side streams may be upgraded to more valuable products, for example by isolation of alginate, fucoidan, laminarin, phytosterols, pigments and sugars. This enables the total usage of the macroalgae. Yet another advantage of the method is that the animal feed obtained by the present method decreases the methane production in cows.

### EXAMPLES

### Example 1

### Pretreatment

Macroalgae (Fucus Vesiculosus) having moisture 55% was pretreated by a rotor-stator to reduce size of macroalgae into size of 1 mm and to break the cell structure of the macroalgae releasing intra and inter cellular components into an aqueous layer. The rotor-stator used was Atrex CD650 G55 with a rotor: 4 spheres, diameter 650 mm and rotational speed 50-1500 rpm.

### Pre-Extraction

The pretreated macroalgae obtained was then separated by pre-extraction performed with alcohol to provide liquid phase containing water soluble materials and solid material. This extraction was carried out with acetone/methanol mixture in ratio 6:4 to remove liquid phase comprising pigments, tannins and proteins. The liquid phase obtained was further separated using a column chromatography to collect Product A (pigments) and residue solid material separately.

### Purification and Separation of Solid Phase

Solid phase obtained in pre-extraction was purified using acid wash for lowering the mineral concentration of the macroalgae. Acid wash was performed using HCl in pH 3. After the purification the solid phase was treated in a second extraction, reactive extraction. The purified solid phase having moisture content 75% was fed through a twin screw press extruder where the reactive extraction was carried out with 20% of Na₂CO₃/dry macroalgae and a solution of 1.5% Na₂CO₃/total water in pH 8.5. This step separated the liquid aqueous phase containing all the water soluble materials (polysaccharides, sugars, etc.) from the solid material providing Product B and macroalgae biomass product. Product B containing polysaccharides and sugars was collected from the process. Polysaccharides such as alginate, fucoidan and laminarin as well as mixtures of sugars were isolated and further purified using known methods. Solid material was collected as macroalgae biomass product. The macroalgae biomass product obtained has a specific composition (Na, Ca, N, P) originating from the process (fingerprint). This biomass was then further extracted to obtain phytosterols and refined macroalgae biomass product.

### Extraction of Phytosterols

Macroalgae biomass product obtained was treated to extract phytosterols using aqueous solution containing ethanol with ethanol content 65% to provide phytosterols and refined macroalgae biomass product. Macroalgae biomass product was fed into a Lodige extraction vessel where an aqueous solution containing ethanol was used for extraction of phytosterols (fucosterol). Reaction time used was 4 hours, temperature 60-80° C. and the solid to solvent ratio was 1:30. The remaining solid material, the refined macroalgae biomass product, was used as animal feed.

### Example 2

Chemical composition of three samples were studied. Animal feed prepared by the process described in Example 1 was compared with two other samples of macroalgae. Sample 1 was original raw material, Fucus Vesiculosus. Sample 2 was Fucus Vesiculosus processed with HCl and mechanical treatment and sample 3 was Fucus Vesiculosus processed according to Example 1.

Standard laboratory procedures for feed analyses at Luke Animale laboratorium in Jokioinen, Finland were used for pretreating (drying, grinding) and analysing the samples. The laboratory has a quality system which follows the SFS-EN ISO/IEC 17025:2005 standards and it is accredited by FINAS (the Finnish Accreditation Service) with number T024.

Samples were chopped with scissors, freeze-dried and primary DM determined before analysis (Christ gamma freeze dryer 2-20 with controller LMC-2, Martin Christ Gefriertrocknungsanlagen GmbH, Osterode am Harz, Germany. Drying period 3-4 days beginning with −25° C., 0.370 mbar). Samples were grinded using sample mill (Sakomylly KT-120, Koneteollisuus Oy, Finland) and 1 mm sieve and the dry matter (DM) concentration was determined by drying the grinded material at 105° C. for 20 h.

Ash content was determined according to the official method AOAC-942.05 (method 942.05, Association of Official Analytical Chemists, USA) by igniting the samples in a muffle furnace at 600° C. for 2 h. Nitrogen (N) content was determined from fresh sample by the accredited Kjeldahl method JOK2002 (based on method AOAC 984.13 using Cu as a digestion catalyst and Foss Kjeltec 2400 Analyzer Unit (Foss Tecator AB, Sweden). Crude protein content was calculated as 6.25×N content. The crude fat concentration was determined after a HCl incubation using an accredited In-house method JOK3008: AOAC Official Method 920.39 Fat (Crude) or Ether Extract in animal Feed) and AACC method 30-25 Crude fat in Wheat, Corn, and Soy Flour, Feeds, and Mixed Feeds. The equipment used was automated extraction unit Soxtec™ 8000, (FOSS Analytical, Denmark).

The water soluble carbohydrates were analysed according to Somogyi (1945) from water extracted fresh sample using Waring Blender laboratory mixer with ratio of 1:15. The concentration of neutral detergent fibre (NDF) was determined using an accredited In-House Method Luke-JOK3007: ISO 16472:2011. The equipment used is Fibertec™ System M (Foss Tecator AB, Sweden). Detergent solution was made according to Van Soest et al (1991). Sodium sulphite was used in NDF-detergent solution. NDF is expressed without residual ash. Samples for the mineral analysis were digested by the closed wet HNO3-H2O2 digestion method in a microwave (CEM MDS 2000) and the extract was analyzed by a iCAP 6500 DUO ICP-emission spectrometer (Thermo Scientific, United Kingdom) (Kalra 1998).

The in vitro pepsin-cellulase solubility of the materials was analysed using a modification of the method described by Nousiainen et al. (2003). The chemical composition of the analysed samples is presented in Table 1. As a reference, typical quality grass silage from Feed Tables (code 07002, Grass silage, average/early 1st cut; Luke 2020) has been added into the Tables. The processed samples contained less DM than the intact material.

TABLE 1
Chemical composition and cellulase solubility
of the bladder wrack samples.

| | | Sam- | Sam- | Sam- | Grass silage |
|---|---|---|---|---|---|
| Parameter | Unit | ple 1 | ple 2 | ple 3 | (code 07002)* |
| Primary dry | g/kg | 203 | 81 | 98 | 250 |
| matter (DM) | | | | | |
| Ash | g/kg DM | 210 | 280 | 303 | 80 |
| Crude protein | g/kg DM | 115 | 147 | 119 | 160 |
| Crude fat | g/kg DM | 32 | 24 | 29 | 40 |
| Neutral | g/kg DM | 257 | 262 | 385 | 550 |
| detergent fibre | | | | | |
| Water soluble | g/kg DM | 97 | 103 | 125 | 50 |
| carbohydrates | | | | | |
| Uncovered | g/kg DM | 280 | 184 | 38 | |
| DM** | | | | | |
| Cellulase | g/kg OM | 781 | 660 | 663 | 776 |
| solubility | | | | | |

OM = Organic matter
*A typical grass silage model feed from Feed Tables (www.luke.fi/feedtables) has been added as a reference.
**1000-ash-crude protein-crude fat-neutral detergent fibre-water soluble carbohydrates

TABLE 2
Mineral composition in bladder wrack samples.

| | | | | | |
|---|---|---|---|---|---|
| | | Sam- | Sam- | Sam- | Grass silage |
| Parameter | Unit | ple 1 | ple 2 | ple 3 | (code 07002)* |

Macrominerals

| | | | | | |
|---|---|---|---|---|---|
| Ca | g/kg DM | 17.7 | 39.9 | 42.1 | 3.8 |
| P | g/kg DM | 2.47 | 2.66 | 1.66 | 3.2 |
| K | g/kg DM | 29 | 21 | 10.3 | 31 |
| Mg | g/kg DM | 9.6 | 8.3 | 6.34 | 1.7 |
| Na | g/kg DM | 16.5 | 5.28 | 38.6 | 0.2 |
| Total | g/kg DM | 75.2 | 77.1 | 99 | 39.9 |
| Uncovered | g/kg DM | 145 | 203 | 204 | 40.1 |
| minerals** | | | | | |

Microminerals

| | | | | | |
|---|---|---|---|---|---|
| Fe | mg/kg DM | 390 | 2600 | 1400 | 180 |
| Mn | mg/kg DM | 390 | 560 | 400 | 61 |
| Cu | mg/kg DM | 2.1 | 13 | 8.8 | 70 |
| Zn | mg/kg DM | 32 | 49 | 54 | 31 |

*A typical grass silage model feed from Feed Tables (www.luke.fi/feedtables) has been added as a reference.
**Ash content - analysed minerals

The ash concentration in the intact material was clearly higher than in typical feeds, and even higher in the processed materials. The analysed minerals (Table 2) constitute only ca. 30% of the ash content, and thus it remains unclear what is the mineral profile of the material. The Na concentration of the material is clearly higher than in typical feeds. The CP content of the materials is lowish. The sugar content of the materials was rather high and that of fibre (NDF) quite low. The treatments clearly reduced the amount of analysed materials. Although the cellulase solubility indicating the energy value of the samples was rather high, the inter-pretation of this value is challenging because it is feed type dependent. Because the NDF concentration of the material was low, it seems that the cellulase solubility of the fibre fraction was actually rather low. The crude fat content of the materials was rather low.

### Example 3

Animal feed (refined macroalgae biomass product) prepared from Fucus vesiculosus by the process of Example 1 was studied for rumen CO₂ production. Measurements were conducted in a Gas Endeavour respirometer (Bioprocess Control). The chemical composition of feeds used in the experiment is given in Table 3. Grass silage was predried first-cutting timothy hay—meadow fescue silage. Grass silage and macroalgae feed were freeze-dried and ground with a hammer mill (Sakomylly KT-120, Koneteollisuus Oy) using a 1 mm sieve. Barley kernels were air-dried and ground similarly. Rumen content was collected from two rumen fistulated Ayrshire cows before morning feeding. Rumen content was filtered using a 250 μm sieve and diluted (1:2) in a buffer solution (McDougall, 1948).

TABLE 3
Chemical composition of feeds.

| | Grass | Barley | |
|---|---|---|---|
| Feed | silage | kernel | Macroalgae |
| pH | 4.72 | | 9.31 |
| Dry matter, g/kg | 393 | 869 | 121 |
| Ammonium nitrogen, g/kg N | 36.5 | | |
| D-value, g/kg DM | 693 | | |
| Neutral detergent fibre, g/kg DM | 515 | 155 | 487 |
| Sugars (dry sample), g/kg DM | | | 17.9 |
| Sugars (wet sample), g/kg DM | 157 | | 24.2 |
| Ash, g/kg DM | 74.0 | 26.3 | 237 |
| Starch, g/kg DM | 2.5 | 537 | 10.0 |
| Total fat, g/kg DM | 25.6 | 28.7 | 17.0 |
| Crude protein, g/kg DM | 146 | 124 | 124 |
| Lactic acid, g/kg DM | 3.26 | | |
| Ethanol, g/kg DM | 11.0 | | |
| Acetic acid, g/kg DM | 1.57 | | |
| Propionic acid, g/kg DM | 1.94 | | |
| Butyric acid, g/kg DM | 0.06 | | |

DM = dry matter.

The amount of dry matter in feed introduced to the Gas Endeavour incubation flasks was standardized as 6 g/flask. The amount of macroalgae feed was increased so that it replaced barley and silage 0, 10, 20, 40, 80, or 160 g/kg diet dry matter (see Table 4). The ratio of grass silage to barley (55:45) remained constant throughout the experiment. Diluted rumen content and feed were added to the Gas Endeavour incubation flasks having a volume 500 ml. The flasks were incubated in a water bath at 39° C. for 23 hours, and volume of CO₂ formed in the flasks was measured during incubation. After end of incubation, pH of the content of the flasks was determined. The non-digested feed residue was dried and weighed. The study was repeated over four consecutive days. Results are given in Table 5.

TABLE 4
Composition of diets. DM = dry matter.

| Macroalgae feed in diet (g/kg diet DM) | | | | | |
|---|---|---|---|---|---|
| 0 | 10 | 20 | 40 | 80 | 160 |

Content of feed in diet, g/kg DM

| | | | | | | |
|---|---|---|---|---|---|---|
| Grass silage | 550 | 545 | 539 | 528 | 506 | 462 |
| Barley | 450 | 446 | 441 | 432 | 414 | 378 |
| Macroalgae feed | 0 | 10 | 20 | 40 | 80 | 160 |

Chemical composition of diet, g/kg DM

| | | | | | | |
|---|---|---|---|---|---|---|
| Crude protein | 136 | 136 | 136 | 136 | 135 | 134 |
| Total fat | 27 | 27 | 27 | 27 | 26 | 25 |
| Neutral detergent fibre | 353 | 355 | 356 | 358 | 364 | 374 |
| Starch | 243 | 241 | 238 | 234 | 224 | 206 |
| Ash | 53 | 54 | 56 | 60 | 67 | 82 |
| Organic matter | 947 | 946 | 944 | 940 | 933 | 918 |

TABLE 5
CO₂ production with different diets. Results are averages of all four days of the experiment
calculated by least square means, except 0 and 20 g/kg DM results are averages of first three
days. DM = dry matter, SEM = standard error of the mean. The P value given below is linear.

| | Macroalgae feed in diet, g/kg DM | | | | | | | |
|---|---|---|---|---|---|---|---|---|
| | 0 | 10 | 20 | 40 | 80 | 160 | SEM | P value |
| CO₂, ml/flask/day | 749 | 735 | 708 | 694 | 636 | 583 | 74.4 | 0.054 |
| CO₂, ml/g incubated | 125 | 122 | 118 | 115 | 106 | 97.5 | 12.5 | 0.058 |
| feed DM | | | | | | | | |
| CO₂, ml/g digested | 367 | 360 | 370 | 340 | 344 | 335 | 31.9 | 0.369 |
| feed DM | | | | | | | | |
| End pH | 6.22 | 6.24 | 6.22 | 6.22 | 6.28 | 6.35 | 0.023 | <0.001 |
| DM digestibility, g/g | 0.358 | 0.342 | 0.333 | 0.344 | 0.308 | 0.290 | 0.029 | 0.079 |

Dry matter digestibility (g/g) and CO₂ production in ml per g of digested feed DM were calculated based on non-digested feed residue. Statistical analysis was performed with SAS mixed procedure. The result is statistically significant if p≤0.05, and indicative of statistical significance if 0.05<P≤0.1. A decrease in CO₂ production was detected as the amount of macroalgae feed in the diet increased. The result was statistically indicative in CO₂ production in ml/flask/day as well as ml/g incubated feed DM. There was no statistical significance in CO₂ production in ml/g digested feed DM, but the results still show a decreasing trend which may be strengthened by diet optimization. Livestock are considered to be responsible for up to 14% of all greenhouse emissions from human activities, and carbon dioxide is one of the greenhouse gasses released by ruminants such as cows. By reducing CO₂ emissions, the macroalgae feed may help reduce the contribution livestock farming is making to global warming.

1. A method for preparing animal feed comprising performing the steps of:
a) providing a mixture comprising macroalgae and water and performing at least one pretreatment of said mixture to break cell structure of the macroalgae;
b) separation of pretreated mixture obtained in step a) to obtain liquid phase and solid phase and recovering the obtained phases separately;
c) purification of the solid phase obtained in step b) by addition of aqueous acidic solution into the solid phase to lower mineral content of the solid phase and recovering purified solid phase and aqueous phase separately;
d) extraction of the purified solid phase obtained in step c) in alkaline conditions by adding basic solution to provide solid macroalgae biomass product animal feed and liquid product B comprising polysaccharides and sugars and recovering the macroalgae biomass product animal feed and product B separately.

2. The method for preparing animal feed according to claim 1, wherein pretreatment is mechanical pretreatment, or wherein chemical and/or enzymatic pretreatment is combined with mechanical pretreatment.

3. (canceled)

4. The method for preparing animal feed according to claim 1, wherein chemical pretreatment is performed by degradation of plant cell walls with formic acid blends.

5. The method for preparing animal feed according to claim 1 wherein separation in step b) is pre-extraction carried out using aqueous solution containing alcohol or mixture of alcohol(s) and organic solvents.

6. The method for preparing animal feed according to claim 1, wherein liquid phase obtained in step b) contains pigments, tannins and proteins.

7. The method for preparing animal feed according to claim 1, wherein purification in step c) is acid wash performed using an effective amount of mineral acid, preferably HCl.

8. The method for preparing animal feed according to claim 1, wherein extraction performed in step d) is reactive extraction performed using aqueous solution of Na₂CO₃, NaOH or KOH.

9. The method for preparing animal feed according to claim 1, wherein in step d) solid phase obtained in step c) is fed through a twin screw press extruder where the reactive extraction is carried out with base (5-10% aqueous solution).

10. The method for preparing animal feed according to claim 1, wherein macroalgae is brown macroalgae.

11. The method for preparing animal feed according to claim 1, wherein the method further comprises the step of:
e) extracting the macroalgae biomass product obtained in step d) to provide phytosterols (product F) and purified macroalgae biomass product animal feed and recovering the obtained product F and purified macroalgae biomass product animal feed separately.

12. The method for preparing animal feed according to claim 1, wherein the method further comprises the step of:
o) separating the liquid phase obtained in step b) to provide product A and residue solid material and recovering the obtained product A and residue solid material separately, wherein product A is pigments.

13. (canceled)

14. The method for preparing animal feed according to claim 1, wherein each of steps a) to d) is performed at a temperature of 0° ° C. to 80° C., preferably 0° ° C. to less than 40° C., more preferably 10° C. to less than 40° C.

15. The method for preparing animal feed according to claim 11, wherein step e) is performed at a temperature of 0° C. to 80° C., preferably 60° ° C. to 80° C.

16. Animal feed obtained by the method according to claim 1, wherein the animal feed contains in dry matter:
i. 0.1 to 6 wt % Na, preferably 0.5 to 6 wt % Na, more preferably 0.5 to 5 wt % Na, most preferably 1 to 5 wt % Na;
ii. 4 to 12 wt % or 1 to 12 wt % Ca, preferably 1 to 10 wt % Ca, more preferably 2 to 10 wt % Ca;
iii. up to 2.5 wt % K, preferably 0.01 to 2.5 wt % K, more preferably 0.1 to 2 wt % K, most preferably 0.1 to 1.5 wt % K; and/or
iv. at least 500 ppm Fe, or at least 800 ppm Fe, or at least 1000 ppm Fe.

17. The animal feed according to claim 16 iv., wherein the animal feed contains up to 3000 ppm Fe, preferably up to 2500 ppm Fe, more preferably up to 2000 ppm Fe in dry matter.
